(19) United States
(12) Patent Application Publication
(10) Pub. No.: US 2014/0053692 A1
(43) Pub. Date: Feb. 27, 2014

(54) Socket Assembly

(71) Applicant: Bobby Hu, Taichung (TW)

(72) Inventor: Bobby Hu, Taichung (TW)

(21) Appl. No.: 13/678,641

(22) Filed: Nov. 16, 2012

(30) Foreign Application Priority Data
Aug. 27, 2012 (TW) 101131040

(51) Int. Cl. B25B 13/06

(52) U.S. Cl. CPC B25B 13/06
USPC 81/121.1

(57) ABSTRACT

A socket assembly includes a body having a driving portion to be driven by a driving tool and a transmission portion for driving a fastener. The transmission portion includes a first end and a second end spaced from the first end along a longitudinal axis. The first end of the transmission portion is connected to the driving portion. A sleeve is mounted around the second end of the transmission portion. A jacket is mounted around the transmission portion and the outer periphery of the sleeve. The transmission portion of the body and an outer periphery of the sleeve are visible through outer and inner peripheries of the jacket.

### BACKGROUND OF THE INVENTION

The present invention relates to a socket assembly and, more particularly, to a socket assembly for aluminum alloy wheels.

Aluminum alloy wheels are liable to scratch while using conventional sockets for detachment and mounting purposes. The scratch is more serious due to vibration if pneumatic wrenches are used, which is a troublesome and difficult problem to users. In an approach, a color plastic sleeve is mounted around a socket for aluminum alloy wheels, avoiding direct impact to the aluminum alloy wheels whiling indicating the size of the socket by the color of the plastic sleeve. However, the diameters of bolts on aluminum alloy wheels are smaller than regular bolt sizes such that these bolts can not be rotated by regular sockets. Thus, the size requirements of the sockets for aluminum alloy wheels are strict. However, the structural strength of a socket for aluminum alloy wheels reduces if the size of the socket is reduced. A socket with an increased thickness for maintaining the structural strength is not suitable for detachment/mounting of aluminum alloy wheels.

Thus, a need exists for a novel socket assembly that mitigates and/or obviates the above disadvantages.

### BRIEF SUMMARY OF THE INVENTION

The present invention solves this need and other problems in the field of sockets by providing a socket assembly including a body having a driving portion and a transmission portion. The transmission portion includes a first end and a second end spaced from the first end along a longitudinal axis. The first end of the transmission portion is connected to the driving portion. The driving portion is adapted to be driven by a driving tool. The transmission portion is adapted to drive a fastener. A sleeve is mounted to the second end of the transmission portion. The sleeve includes an outer periphery surrounding the longitudinal axis. A jacket is mounted around the transmission portion and the outer periphery of the sleeve. The jacket includes first and second ends spaced from each other along the longitudinal axis. The jacket further includes an outer periphery extending between the first and second ends of the jacket. The jacket further includes an inner periphery extending between the first and second ends of the jacket and surrounded by the outer periphery of the jacket. The transmission portion of the body and the outer periphery of the sleeve are visible through the outer and inner peripheries of the jacket.

Preferably, a lip extends inward from the second end of the socket in a radial direction perpendicular to the longitudinal axis. The lip abuts an end face of the sleeve facing away from the driving portion of the body.

In an example, the outer periphery of the sleeve has a color different from that of the transmission portion of the body, and the jacket is made of a transparent material.

In another example, the outer periphery of the sleeve has a color the same as that of the transmission portion of the body, and the jacket is made of a light-transmittable color material.

In a further example, the jacket includes a plurality of ribs formed on the inner periphery of the jacket. The ribs are spaced from each other at regular intervals along the longitudinal axis. The ribs abuts the transmission portion of the body and the outer periphery of the sleeve, with a plurality of gaps defined between the inner periphery of the jacket and the transmission portion of the body and between the inner periphery of the jacket and the outer periphery of the sleeve, with the plurality of gaps spaced from each other along the longitudinal axis.

The body can include a flange between the driving portion and the transmission portion. A diameter of the transmission portion perpendicular to the longitudinal axis is larger than a diameter of the driving portion perpendicular to the longitudinal axis and smaller than a diameter of the flange perpendicular to the longitudinal axis. The flange has an abutment face facing the sleeve. The abutment face is annular and has a width perpendicular to the longitudinal axis, with the width being a half of a difference between the diameters of the transmission portion and the flange. An end face of the first end of the jacket abuts the abutment face of the flange. A thickness between the outer and inner peripheries of the jacket is equal to the width of the flange.

In an example, the jacket is elastic. A diameter of the inner periphery of the jacket perpendicular is smaller than the diameter of the transmission portion. The inner periphery of the jacket tightly presses against the transmission portion of the body and the outer periphery of the sleeve by force of restitution of the jacket.

In another example, the diameter of the inner periphery of the jacket is equal to the diameter of the transmission portion.

Preferably, the second end of the transmission portion of the body includes an inner periphery and an outer periphery. The sleeve abuts the outer periphery of the second end of the transmission portion. The inner periphery of the second end of the transmission portion has non-circular cross sections and defines an engagement hole. The engagement hole is adapted to receive and drive the fastener.

The sleeve can be made of a metal different from that of the body.

Preferably, the jacket is made of a material having a transmittance and a haze, with the transmittance and the haze of the material allowing the transmission portion of the body and the outer periphery of the sleeve to be visible through the outer and inner peripheries of the jacket.

The jacket can be made of plastic material.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a socket assembly of a first embodiment according to the present invention.

FIG. 2 shows an exploded, perspective view of the socket assembly of FIG. 1.

FIG. 3 shows a cross sectional view of the socket assembly of FIG. 1.

FIG. 4 shows a perspective view of a socket assembly of a second embodiment according to the present invention.

FIG. 5 shows an exploded, perspective view of the socket assembly of FIG. 4.

FIG. 6 shows a cross sectional view of a socket assembly of a third embodiment according to the present invention.

FIG. 7 shows a perspective view illustrating use of the socket assembly according to the present invention on an aluminum alloy wheel.

FIG. 8 shows an enlarged, cross sectional view of a portion of FIG. 7.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “third”, “fourth”, “end”, “portion”, “longitudinal”, “radial”, “diameter”, “width”, “thickness”, and similar terms are used herein, it should be understood that these terms have reference only to the structure shown in the drawings as it would appear to a person viewing the drawings and are utilized only to facilitate describing the illustrative embodiments.

### DETAILED DESCRIPTION OF THE INVENTION

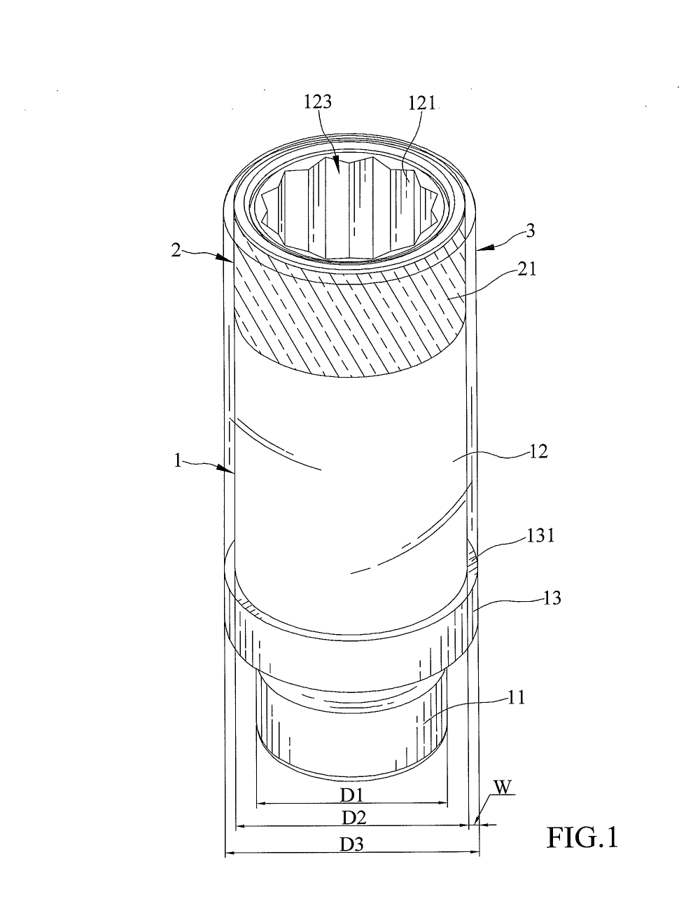

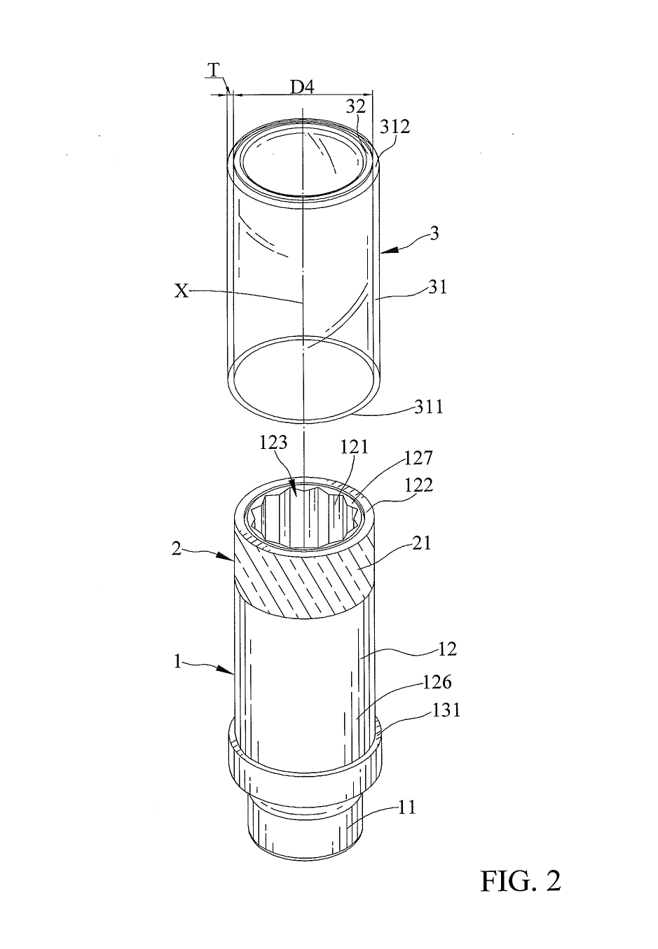

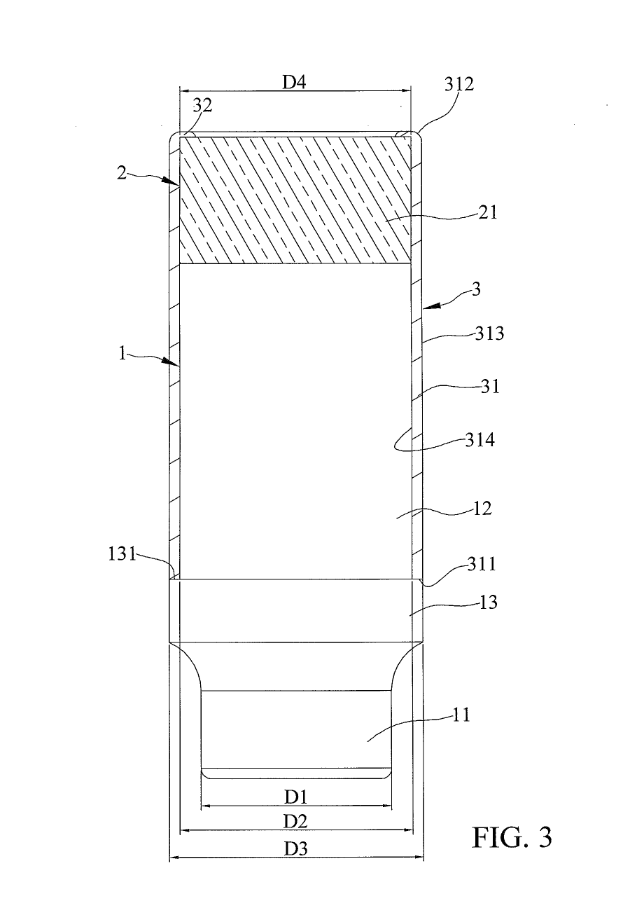

FIGS. 1-3 show a first embodiment of a socket assembly according to the present invention is shown in the drawings. The socket assembly includes a body 1, a sleeve 2, and a jacket 3. The body 1 is made of metal and includes a driving portion 11 and a transmission portion 12. The transmission portion 12 includes a first end 126 and a second end 127 spaced from the first end 126 along a longitudinal axis X. The first end 126 of the transmission portion 12 is connected to the driving portion 11. The driving portion 11 is adapted to be driven by a driving tool, such as a wrench, a pneumatic tool, an electric tool, or an automated machine. The transmission portion 12 is adapted to drive a fastener, such as a screw, a nut, or the like. In this embodiment, the second end 127 of the transmission portion 12 of the body 1 includes an inner periphery 121 and an outer periphery 122. The second end 127 of the inner periphery 121 of the transmission portion 12 has non-circular cross sections and defines an engagement hole 123 for receiving and driving the fastener. A flange 13 is formed between the driving portion 11 and the transmission portion 12 of the body 1. The driving portion 11 has a first diameter D1 perpendicular to the longitudinal axis X. The transmission portion 12 has a second diameter D2 perpendicular to the longitudinal axis X. The flange 13 has a third diameter D3 perpendicular to the longitudinal axis X. The second diameter D2 is larger than the first diameter D1 and smaller than the third diameter D3. The outer periphery 122 of the second end 127 of the transmission portion 12 has an outer diameter smaller than the second diameter D2.

Since the second diameter D2 is smaller than the third diameter D3, the flange 13 has an abutment face 131 facing the sleeve 2. The abutment face 131 is annular and has a width W perpendicular to the longitudinal axis X. The width W is a half of a difference between the second and third diameters D2 and D3.

The sleeve 2 is securely mounted to the second end 127 of the transmission portion 12. The sleeve 2 abuts the outer periphery 122 of the second end 127 of the transmission portion 12. The sleeve 2 includes an outer periphery 21 surrounding the longitudinal axis X. The outer periphery 21 of the sleeve 2 has a diameter perpendicular to the longitudinal axis X and equal to the second diameter D2. The sleeve 2 is made of a metal (such as aluminum) different from that of the body 1. The sleeve 2 can have a color the same as that of the body 1. Nevertheless, the sleeve 2 can have a color different from that of the body 1. A coating containing the metal material of the sleeve 2 can be formed on the sleeve 2 by chemical or electrochemical processing, including electroplating or conversion coating, such as chromate coating of zinc, phosphate coating of steel, and anodizing of aluminum alloy. Furthermore, the outer periphery 21 of the sleeve 2 can be processed to have a color different from that of the body 1. Thus, the socket assembly can include two colors to indicate the size of the socket to be driven. Further, the sleeve 2 can include patterns on the outer periphery 21 to provide an aesthetic appearance.

The jacket 3 is mounted around the transmission portion 12 and the outer periphery 21 of the sleeve 2. The jacket 3 is cylindrical and can be made of plastic material to avoid an aluminum alloy wheel from being scratched while using the body 1 and the sleeve 2. The jacket 3 includes a body portion 31 having first and second ends 311 and 312 spaced from each other along the longitudinal axis X. The body portion 31 of the jacket 3 further includes an outer periphery 313 extending between the first and second ends 311 and 312 of the jacket 3. The jacket 3 further includes an inner periphery 314 extending between the first and second ends 311 and 312 of the jacket 3 and surrounded by the outer periphery 313 of the jacket 3. An end face of the first end 311 of the jacket 3 abuts the abutment face 131 of the flange 13. A thickness T of the jacket 3 between the outer and inner peripheries 313 and 314 of the jacket 3 is equal to the width W of the flange 13. The inner periphery 314 of the jacket 3 has a fourth diameter D4 perpendicular to the longitudinal axis X. The fourth diameter D4 can be smaller than or equal to the second diameter D2. The jacket 3 is elastic. The inner periphery 314 of the jacket 3 tightly presses against the transmission portion 12 of the body 1 and the outer periphery 21 of the sleeve 2 by force of restitution of the jacket 3. The jacket 3 is light-transmittable. The jacket 3 is made of a material having a transmittance and a haze, with the transmittance and the haze of the material allowing the transmission portion 12 of the body 1 and the outer periphery 21 of the sleeve 2 to be visible through the outer and inner peripheries 313 and 314 of the jacket 3. The jacket 3 can be transparent or translucent. Thus, the transmission portion 12 of the body 1 and the outer periphery 21 of the sleeve 2 are visible through the inner and outer peripheries 313 and 314 of the jacket 3.

In a case that the sleeve 2 and the body 1 have an identical color, the jacket 3 is transparent and made of a material allowing the outer periphery 21 of the sleeve 2 to be visible through the outer and inner peripheries 313 and 314 of the jacket 3. A user can directly see the color difference between the outer periphery 21 of the sleeve 2 and the transmission portion 12 of the body 1 to identify the size of the fastener corresponding to the socket assembly.

In another case that the sleeve 2 and the body 1 have different colors, the jacket 3 is made of a color material allowing the outer periphery 21 of the sleeve 2 to be seen through the outer and inner peripheries 313 and 314 of the jacket 3. The user can directly see the colors of the outer periphery 21 of the sleeve 2 and the transmission portion 12 of the body 1 as well as the color of the jacket 3 to identify the size of the fastener corresponding to the socket assembly.

A lip 32 extends inward from the second end 312 of the socket 3 in a radial direction perpendicular to the longitudinal axis X. The lip 32 abuts an end face of the sleeve 2 facing away from the driving portion 11 of the body 1. In use of the socket assembly on an aluminum alloy wheel, the lip 32 prevents the aluminum alloy wheel from being scratched by the second end 127 of the body 1 and the end face of the sleeve 2 facing away from the driving portion 11 of the body 1.

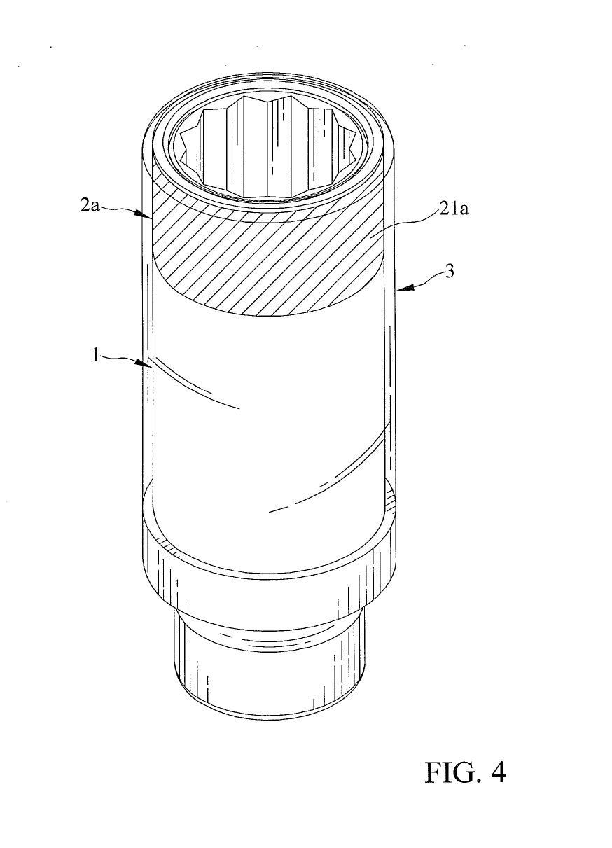

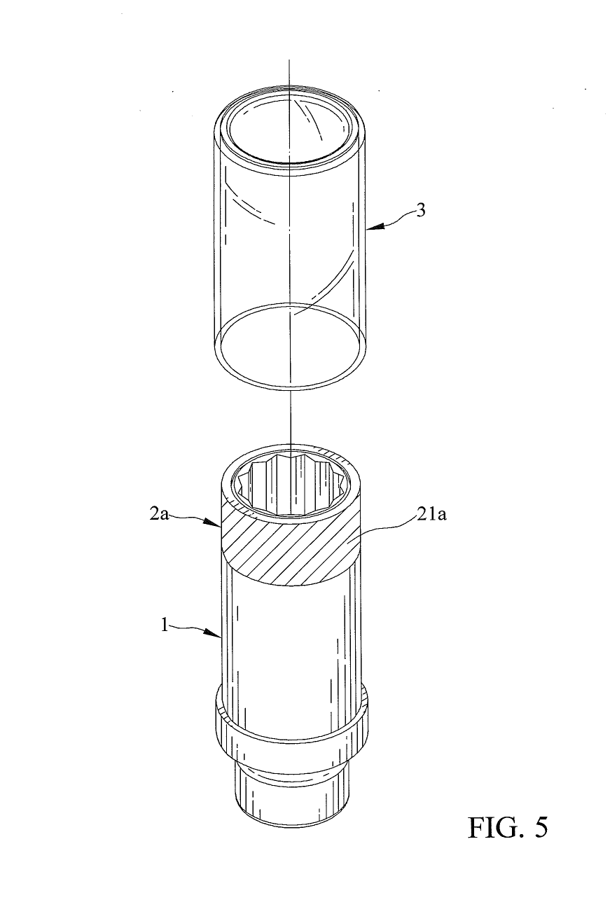

FIGS. 4 and 5 show a second embodiment of the socket assembly. Specifically, the color of the outer periphery 21a of the sleeve 2a is different from that of the sleeve 2 in FIG. 1, providing identification of the size of the fastener corresponding to the socket assembly.

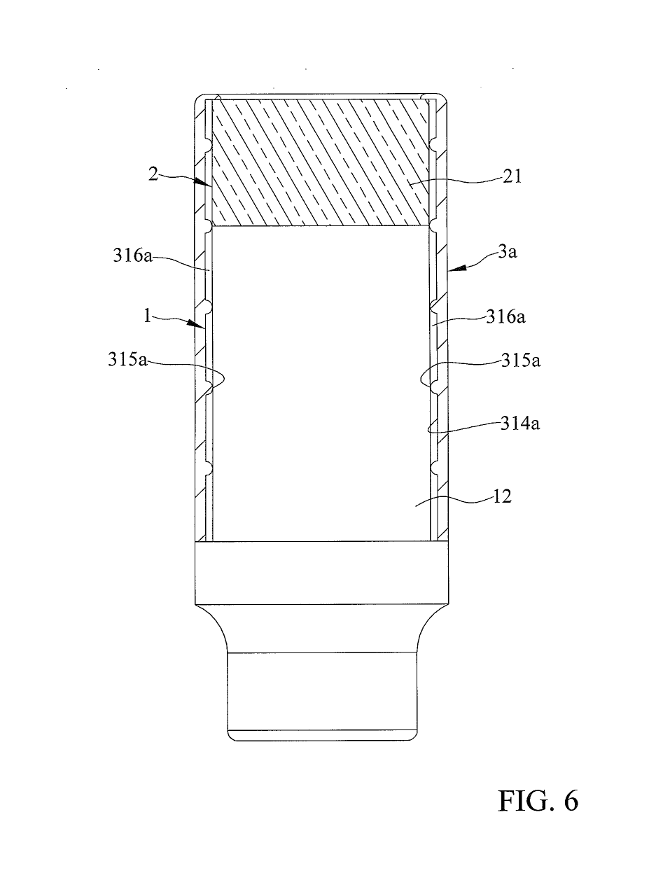

FIG. 6 shows a third embodiment of the socket assembly. Specifically, a plurality of ribs 315a is formed on the inner periphery 314a of the jacket 3a. The ribs 315a are spaced from each other at regular intervals along the longitudinal axis X. The ribs 315a abut the transmission portion 12 of the body 1 and the outer periphery 21 of the sleeve 2, with a plurality of gaps 316a defined between the inner periphery 314a of the jacket 3a and the transmission portion 12 of the body 1 and between the inner periphery 314a of the jacket 3a and the outer periphery 21 of the sleeve 2, with the plurality of gaps 316a spaced from each other along the longitudinal axis X. In a case that a working fluid, such as a lubricating oil, enters a space between the jacket 3 and the transmission portion 12 of the body 1 or between the jacket 3a and the outer periphery 21 of the sleeve 2 while using the socket assembly to detach or mount an aluminum alloy wheel, the gaps 316a can receive the working fluid to avoid generation of irregular areas of stain resulting from spread of the lubricating oil between the body 1, the sleeve 2, and the jacket 3a due to adhesion and surface tension, preventing adverse effect to identification of the color difference.

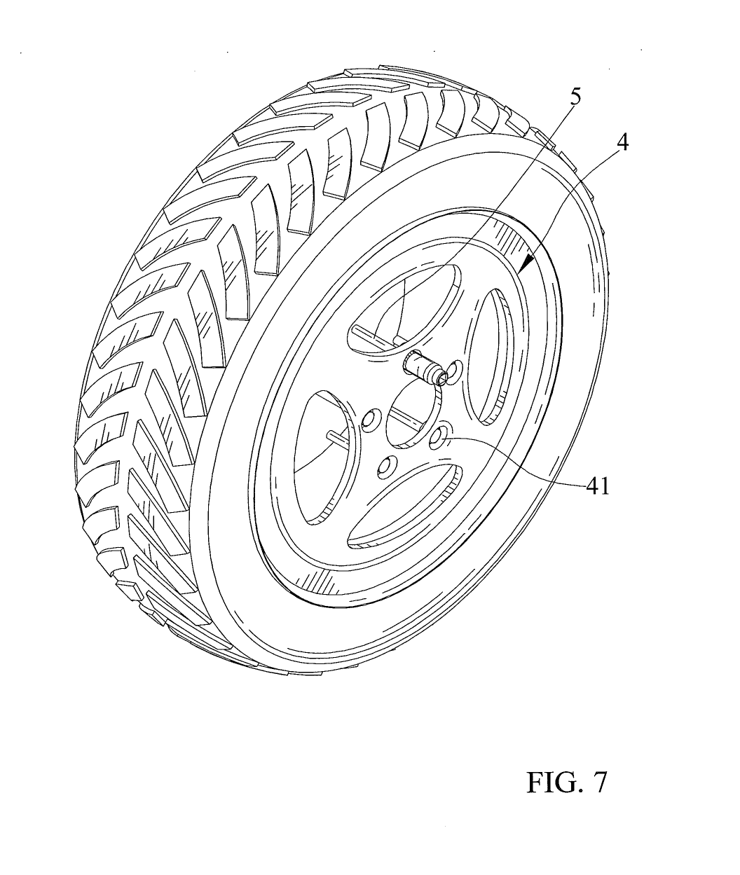

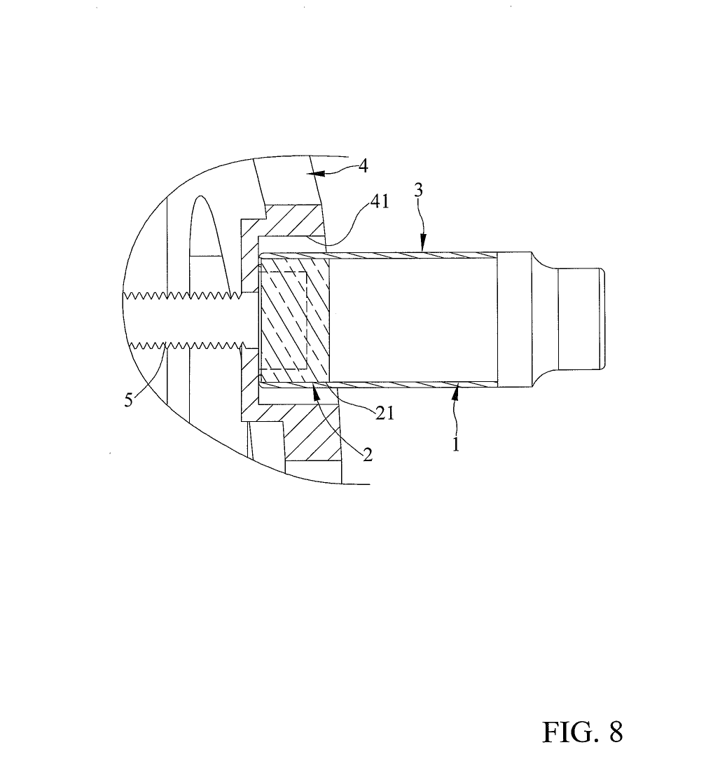

FIGS. 7 and 8 illustrate use of the socket assembly on an aluminum alloy wheel 4 having a plurality of screw holes 41 (five screw holes 41 in the form shown). The socket assembly is extended through one of the screw holes 41 and engaged with a fastener 5. The color of the outer periphery 21 of the sleeve 2 allows identification of the size of the fastener 5 corresponding to the socket assembly.

The socket assembly includes the following advantages:

1. The jacket 3, 3a is made of a material having a transmittance and a haze allowing the transmission portion 12 of the body 1 and the outer periphery 21, 21a of the sleeve 2, 2a to be visible through the outer and inner peripheries 313 and 314 of the jacket 3, 3a. Thus, the jacket 3, 3a can be transparent or translucent to allow the user to clearly identify the colors of the body 1 and the sleeve 2, 2a.

2. The color of the sleeve 2, 2a can be different from that of the body 1, and the jacket 3, 3a can be transparent to allow the user to directly see the color difference between the sleeve 2, 2a and the body 1, identifying the size of the fastener 5 corresponding to the socket assembly. Furthermore, the jacket 3, 3a can be made of a color material allowing the user to see the transmission portion 12 of the body 1 and the outer periphery 21, 21a of the sleeve 2, 2a as well as the color of the jacket 3, 3a, identifying the size of the fastener 5 corresponding to the socket assembly.

3. The ribs 315a on the inner periphery 314a of the jacket 3a define the gaps 316a between the inner periphery 314a of the jacket 3a and the transmission portion 12 of the body 1 and between the inner periphery 314a of the jacket 3a and the outer periphery 21 of the sleeve 2. In a case that a working fluid, such as a lubricating oil, enters the space between the jacket 3a and the transmission portion 12 of the body 1 or between the jacket 3 and the outer periphery 21 of the sleeve 2 while using the socket assembly to detach or mount the aluminum alloy wheel 4, the gaps 316a can receive the working fluid to avoid generation of irregular areas of stain resulting from spread of the lubricating oil between the body 1, the sleeve 2, and the jacket 3a due to adhesion and surface tension, preventing adverse effect to identification of the color difference.

4. The sleeve 2, 2a reinforces the socket assembly to reduce deformation of the transmission portion 12 of the body 1 during use of the socket assembly, reducing damage to the inner periphery 121 of the transmission portion 12 due to fatigue. Namely, the socket assembly has enhanced structural strength and is, thus, more durable.

5. The sleeve 2, 2a can be made of expensive, rigid material. In this case, even if the body 1 is made of inexpensive, less rigid material, the socket assembly still possesses sufficient strength and resistance to fatigue, saving the manufacturing costs.

Now that the basic teachings of the socket assembly have been explained, many extensions and variations will be obvious to one having ordinary skill in the art. For example, the body 1, the sleeve 2, and the jacket 3, 3a can have shapes different from those shown in the figures. Further, the colors of the outer periphery 21, 21a of the sleeve 2, 2a and the material of the jacket 3, 3a can be different from those illustrated.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A socket assembly comprising:
a body including a driving portion and a transmission portion, with the transmission portion including a first end and a second end spaced from the first end along a longitudinal axis, with the first end of the transmission portion connected to the driving portion, with the driving portion adapted to be driven by a driving tool, with the transmission portion adapted to drive a fastener;
a sleeve mounted to the second end of the transmission portion, with the sleeve including an outer periphery; and
a jacket mounted around the transmission portion and the outer periphery of the sleeve, with the jacket including first and second ends spaced from each other along the longitudinal axis, with the jacket further including an outer periphery extending between the first and second ends of the jacket, with the jacket further including an inner periphery extending between the first and second ends of the jacket and surrounded by the outer periphery of the jacket, with the transmission portion of the body and the outer periphery of the sleeve visible through the outer and inner peripheries of the jacket.

2. The socket assembly as claimed in claim 1, with a lip extending inward from the second end of the socket in a radial direction perpendicular to the longitudinal axis, with the lip abutting an end face of the sleeve facing away from the driving portion of the body.

3. The socket assembly as claimed in claim 1, with the transmission portion of the body having a first color, with the outer periphery of the sleeve having a second color different from the first color, with the jacket made of a transparent material.

4. The socket assembly as claimed in claim 1, with the outer periphery of the sleeve having a color the same as a color of the transmission portion of the body, with the jacket made of a light-transmittable color material.

5. The socket assembly as claimed in claim 1, with the jacket including a plurality of ribs formed on the inner periphery of the jacket, with the plurality of ribs spaced from each other at regular intervals along the longitudinal axis, with the plurality of ribs abutting the transmission portion of the body and the outer periphery of the sleeve, with a plurality of gaps defined between the inner periphery of the jacket and the transmission portion of the body and between the inner periphery of the jacket and the outer periphery of the sleeve, with the plurality of gaps spaced from each other along the longitudinal axis.

6. The socket assembly as claimed in claim 1, with the body further including a flange between the driving portion and the transmission portion, with the driving portion having a first diameter perpendicular to the longitudinal axis, with the transmission portion having a second diameter perpendicular to the longitudinal axis, with the flange having a third diameter perpendicular to the longitudinal axis, with the second diameter larger than the first diameter and smaller than the third diameter.

7. The socket assembly as claimed in claim 6, with the flange having an abutment face facing the sleeve, with the abutment face being annular and having a width perpendicular to the longitudinal axis, with the width being a half of a difference between the second and third diameters, with an end face of the first end of the jacket abutting the abutment face of the flange, with the jacket having a thickness between the outer and inner peripheries of the jacket, with the thickness of the jacket equal to the width of the flange.

8. The socket assembly as claimed in claim 6, with the jacket being elastic, with the inner periphery of the jacket having a fourth diameter perpendicular to the longitudinal axis, with the fourth diameter smaller than the second diameter, with the inner periphery of the jacket tightly pressing against the transmission portion of the body and the outer periphery of the sleeve by force of restitution of the jacket.

9. The socket assembly as claimed in claim 6, with the inner periphery of the jacket having a fourth diameter perpendicular to the longitudinal axis, with the fourth diameter equal to the second diameter.

10. The socket assembly as claimed in claim 1, with the second end of the transmission portion of the body including an inner periphery and an outer periphery, with the sleeve abutting the outer periphery of the second end of the transmission portion, with the inner periphery of the second end of the transmission portion having non-circular cross sections and defining an engagement hole, with the engagement hole adapted to receive and drive the fastener.

11. The socket assembly as claimed in claim 1, with the body made of a first metal, with the sleeve made of a second metal different from the first metal.

12. The socket assembly as claimed in claim 1, with the jacket made of a material having a transmittance and a haze, with the transmittance and the haze of the material allowing the transmission portion of the body and the outer periphery of the sleeve to be visible through the outer and inner peripheries of the jacket.

13. The socket assembly as claimed in claim 1, with the jacket made of plastic material.
